(19) United States
(12) Patent Application Publication
(10) Pub. No.: US 2026/0331596 A1
(43) Pub. Date: Oct. 22, 2026

(54) ELECTRODE FOR SECONDARY BATTERIES AND LITHIUM SECONDARY BATTERY INCLUDING THE SAME

(71) Applicant: SK On Co., Ltd., Seoul (KR)

(72) Inventors: Jong Hun PARK, Daejeon (KR); Byung Mook KIM, Daejeon (KR); Mi So RHO, Daejeon (KR); Kyung Tae PARK, Daejeon (KR); Byeong Hyeon PARK, Daejeon (KR); Yong Seok LEE, Daejeon (KR)

(21) Appl. No.: 19/653,119

(22) Filed: Apr. 21, 2026

(30) Foreign Application Priority Data
Apr. 22, 2025 (KR) 10-2025-0052023

(51) Int. Cl. H01M 10/0587; H01M 4/02; H01M 4/62; H01M 10/0525

(52) U.S. Cl. CPC H01M 10/0587; H01M 4/623; H01M 10/0525; H01M 2004/021; H01M 2004/027; H01M 2004/028

(57) ABSTRACT

Disclosed is an electrode for secondary batteries, the electrode including a current collector and an electrode mixture layer disposed on at least one surface of the current collector, wherein the electrode mixture layer is divided into a first region extending a predetermined length from a winding start end in a winding direction and a second region extending from the first region to a winding termination end. Each of the first region and the second region comprises an active material, a conductive agent, and a binder, the first region and the second region include binders with different contents, or the first region and the second region include different types of binders, and the first region has higher ductility than the second region.

### CROSS-REFERENCE TO RELATED APPLICATION

This application claims the benefit of priority to Korean Patent Application No. 10-2025-0052023 filed on Apr. 22, 2025, the disclosure of which is incorporated herein by reference in its entirety.

### TECHNICAL FIELD

Embodiments of the present disclosure relate to an electrode for secondary batteries and a lithium secondary battery including the same, and more particularly to an electrode including a current collector, an active material, a conductive agent, and a binder, and a secondary battery including the same.

### BACKGROUND

A secondary battery, which is a rechargeable battery capable of storing and releasing energy, includes a positive electrode, a negative electrode, an electrolyte, and a separator. Each of the positive electrode and the negative electrode constitutes an electrode including an active material, a conductive agent, a binder, and a current collector. The positive electrode and the negative electrode are core components in which electrochemical reactions occur, and directly influence the performance of the secondary battery.

A jelly-roll type cylindrical secondary battery is manufactured by winding electrodes and a separator on a mandrel. During this process, the electrodes undergo repeated bending and mechanical stress. Particularly, stress may be concentrated on an electrode core with high curvature, necessitating continuous technological development to maintain the structural stability of the electrodes.

The above description is provided to aid in understanding the technical background of the present disclosure. Therefore, the above description should not be interpreted as reducing, limiting, or restricting the technical concept of the present disclosure. In addition, the contents described or implied in the above description do not necessarily constitute prior art. The above description may include contents that do not correspond to certain prior art.

### SUMMARY

Some embodiments of the present disclosure may provide an electrode for secondary batteries with improved durability and stability.

In addition, some embodiments of the present disclosure may provide an electrode for secondary batteries with improved output and capacity.

Some embodiments of the present disclosure may be widely adopted in green technology fields such as electric vehicles, battery charging stations, and other battery-utilizing applications like solar power generation and wind power generation. In addition, some embodiments of the present disclosure may be used in eco-friendly electric vehicles (EVs) and hybrid vehicles (HVs) to prevent climate change by suppressing air pollution and greenhouse gas emissions.

However, aspects of the present disclosure are not necessarily limited to those mentioned in the description. Other unmentioned aspects of the present disclosure will be clearly understood by those skilled in the art from other parts of the specification, such as the detailed description.

According to a first aspect of the present disclosure, there is provided an electrode for secondary batteries, the electrode including a current collector and an electrode mixture layer disposed on at least one surface of the current collector, wherein the electrode mixture layer is divided into a first region extending a predetermined length from a winding start end in a winding direction and a second region extending from the first region to a winding termination end, each of the first region and the second region includes an active material, a conductive agent, and a binder, the first region and the second region include binders with different contents, or the first region and the second region include different types of binders, and the first region has higher ductility than the second region.

According to an exemplary aspect of the present disclosure, each of the first region and the second region may include 93.5 to 97.5 wt % of the active material, 1 to 3 wt % of the conductive agent, and 0.5 to 3.5 wt % of the binder.

According to an exemplary aspect of the present disclosure, the content of the binder included in the second region may be 2 wt % or less of the total weight of the electrode mixture layer in the second region.

According to an exemplary aspect of the present disclosure, the content of the binder in the first region may be higher than the content of the binder in the second region.

According to an exemplary aspect of the present disclosure, the content of the binder included in the first region may be 1.1 to 10 times the content of the binder included in the second region.

According to an exemplary aspect of the present disclosure, the binder in the first region may have higher tensile elongation than the binder in the second region.

According to an exemplary aspect of the present disclosure, the tensile elongation of the binder included in the first region may be 100% or more.

According to an exemplary aspect of the present disclosure, the first region may be a region in which the electrode is wound 1 to 10 times from the winding start end in the winding direction.

According to an exemplary aspect of the present disclosure, the length of the first region may be 80 to 400 mm.

According to an exemplary aspect of the present disclosure, the binder may be at least one selected from the group consisting of polyvinylidene fluoride (PVDF), poly(vinylidene fluoride-co-hexafluoropropylene), polyacrylonitrile, polymethyl methacrylate, nitrile butadiene rubber (NBR), hydrogenated nitrile butadiene rubber (HNBR), polybutadiene rubber (BR), and styrene-butadiene rubber (SBR).

According to an exemplary aspect of the present disclosure, the thickness of the current collector may be 20 μm or less.

According to an exemplary aspect of the present disclosure, the electrode may be a positive electrode or a negative electrode.

According to an exemplary aspect of the present disclosure, the electrode may be a positive electrode and include a positive active material, and the electrode density of the positive electrode active material may be 3 g/cm³ or more.

According to a second aspect of the present disclosure, there is provided an electrode assembly including a positive electrode, a negative electrode, and a separator located between the positive electrode and the negative electrode, wherein the positive electrode is the electrode described above.

According to a third aspect of the present disclosure, there is provided a battery cell including the electrode assembly.

According to a fourth aspect of the present disclosure, there is provided a battery module including at least one battery cell, wherein the battery cell is the battery cell described above.

According to a fifth aspect of the present disclosure, there is provided a battery pack including at least one battery module, wherein the battery module is the battery module described above.

According to a sixth aspect of the present disclosure, there is provided an electrical device including at least one battery pack, wherein the battery pack is the battery pack described above.

### BRIEF DESCRIPTION OF THE DRAWINGS

FIG. 1 is a schematic view showing an electrode for secondary batteries according to an embodiment before winding;

FIG. 2 is a schematic view showing only an electrode mixture layer included in the electrode for secondary batteries according to the embodiment after winding; and

FIG. 3 is a sectional view of the electrode for secondary batteries according to the embodiment after winding when cut in a direction perpendicular to an axial direction of a core member, showing the positional relationship between a first region and a second region and the length of the first region based on a winding start end.

### DETAILED DESCRIPTION

The following embodiments are provided to more fully and completely explain the technical concept of the present disclosure to those skilled in the art to which the present disclosure pertains. Therefore, the technical concept of the present disclosure is not necessarily limited to the following embodiments. The present disclosure should be understood as broadly encompassing various equivalents, substitutes, and adaptations that implement the technical concept described below.

The terms used in the following description are employed from the above perspective to more fully and completely explain specific embodiments. Therefore, the terms used in the following description should not be interpreted as reducing, limiting, or restrict the technical concept of the present disclosure.

In the following description, terms such as “first” and “second” may be used to distinguish specific components from other components. However, such terms are used for clarity of description, and the technical concept of the present disclosure should not be interpreted as limited by such terms.

In the following description, singular expressions may be interpreted as including the plural unless clearly excluded by context. In addition, the expression “includes” in the following description signifies the presence of components, parts, operations, features, steps, numbers, etc., described therein, and does not exclude the addition of one or more other components, parts, operations, features, steps, numbers, etc.

Direction-related terms such as “beneath,” “above,” “lower,” and “upper” may be used in the following description to facilitate understanding of the components. However, such terms are provided for ease of understanding of the present disclosure based on the various operations, use states, etc. of the present disclosure and should not be interpreted as reducing, limiting, or restricting the technical concept of the present disclosure. For example, direction-related terms may be determined from a relative perspective.

In the present disclosure, the meaning that ductility of an electrode or a binder is high or excellent may encompass all of the following meanings: the electrode or the binder has excellent flexibility, the electrode has high resistance to bending deformation, or the electrode has excellent crack resistance during bending or repeated deformation.

According to an embodiment of the present disclosure, a secondary battery electrode including a current collector and an electrode mixture layer disposed on at least one surface of the current collector may be provided.

According to an embodiment of the present disclosure, the electrode may include both a positive electrode and a negative electrode, but more specifically, the electrode may be a positive electrode.

In the present disclosure, the current collector may be used without limitation as long as the current collector is commonly used, and is not particularly limited. Furthermore, a current collector according to an embodiment of the present disclosure may be made of an electrically conductive and electrochemically durable material, but the present disclosure is not limited thereto. The current collector may be made of an appropriate material selected based on whether the electrode is a positive electrode or a negative electrode.

The thickness of the current collector according to the embodiment of the present disclosure may be, for example, 20 μm or less, 1 to 20 μm, 18 μm or less, 1 to 18 μm, 16 μm or less, 1 to 16 μm, 14 μm or less, 1 to 14 μm, 12 μm or less, 1 to 12 μm, 10 μm or less, 1 to 10 μm, 8 μm or less, 1 to 8 μm, 6 μm or less, 1 to 6 μm, 4 μm or less, 1 to 4 μm, 2 μm or less, or 1 to 2 μm, but the present disclosure is not limited thereto.

The current collector may be a positive electrode current collector or a negative electrode current collector depending on the polarity (positive electrode or negative electrode) of the electrode.

The positive electrode current collector is not particularly limited in type, size, or shape as long as the positive electrode current collector has conductivity without inducing chemical changes in a battery cell. A positive electrode current collector according to an embodiment of the present disclosure may be made of, for example, at least one selected from the group of aluminum, an aluminum alloy, nickel, copper, stainless steel, titanium, gold, silver, molybdenum, tantalum, cobalt, iridium, platinum, niobium, metal mesh, metal foam, carbon fiber, carbon paper, carbon cloth, graphene, conductive polymer film, metal-plated plastic, a metal-coated polymer, and a combination thereof, but the present disclosure is not limited thereto. Any current collector adoptable by those skilled in the art may be used without limitation as long as the current collector does not depart from the technical scope of the present disclosure.

The negative electrode current collector is not particularly limited in type, size, or shape as long as the negative electrode current collector has conductivity without inducing chemical changes in the battery cell. A negative electrode current collector according to an embodiment of the present disclosure may be made of, for example, at least one selected from the group of copper foil, a copper alloy, copper foam, nickel foil, a nickel alloy, nickel foam, stainless steel foil, aluminum foil, an aluminum alloy, molybdenum, tantalum, cobalt, titanium foil, silver, gold, platinum, niobium, metal mesh, metal foam, carbon fiber, carbon paper, carbon cloth, graphene, conductive polymer film, metal-plated plastic, a metal-coated polymer substrate, a transition metal-coated polymer substrate, and a combination thereof, but the present disclosure is not limited thereto. Any current collector adoptable by those skilled in the art may be used without limitation as long as the current collector does not depart from the technical scope of the present disclosure.

An electrode mixture layer according to an embodiment of the present disclosure may be formed on at least one surface of the current collector. The electrode mixture layer may include an active material, a conductive agent, and a binder.

The conductive agent may have conductivity without inducing chemical changes in the battery. The conductive agent may be added to enhance conductivity of the electrode mixture layer and/or mobility of lithium ions or electrons.

A conductive agent according to an embodiment of the present disclosure may include, for example, a carbon-based conductive agent, such as graphite, carbon black, acetylene black, Ketjen black, graphene, carbon nanotubes, vapor-grown carbon fiber (VGCF), or carbon fiber, and/or a metal-based conductive agent including tin, tin oxide, titanium oxide, and a perovskite material, such as LaSrCoO₃ or LaSrMnO₃, but the present disclosure is not limited thereto.

When an electrode according to an embodiment of the present disclosure is a positive electrode, the current collector may be a positive electrode current collector, the positive electrode may include a positive electrode mixture layer disposed on at least one surface of the positive electrode current collector, and the positive electrode mixture layer may include a positive electrode active material. The positive electrode mixture layer may be prepared through the following process. For example, a positive electrode slurry may be prepared by mixing a positive electrode active material in a solvent, and a positive electrode mixture layer may be prepared by coating a positive electrode current collector with the prepared positive electrode slurry and drying and rolling the same. Coating may be performed using a gravure coating method, a slot die coating method, a multilayer simultaneous die coating method, an imprinting method, a doctor blade coating method, a dip coating method, a bar coating method, or a casting method, but the present disclosure is not limited thereto. The positive electrode mixture layer may further include a binder, and may optionally further include a conductive agent or a thickening agent. As needed, the positive electrode mixture layer may further include a thickening agent and/or a dispersant. As an embodiment, the positive electrode mixture layer may include a thickening agent such as carboxymethyl cellulose (CMC). Non-limiting examples of a solvent used in preparing the positive electrode mixture layer may include N-methyl-2-pyrrolidone (NMP), dimethylformamide, dimethylacetamide, N,N-dimethylaminopropylamine, ethylene oxide, and tetrahydrofuran.

The positive electrode active material may include a compound capable of reversibly intercalating and deintercalating lithium ions.

According to exemplary embodiments, the positive electrode active material may include a lithium-nickel metal oxide. The lithium-nickel metal oxide may further include at least one of cobalt (Co), manganese (Mn), and aluminum (Al).

In some embodiments, the positive electrode active material or the lithium-nickel metal oxide may include a layered structure or a crystal structure represented by Chemical formula 1 below.

LixNiₐMbO_{2+z} [Chemical formula 1]

In Chemical formula 1, 0.9≤x≤1.2, 0.6≤a≤0.99, 0.01≤b≤0.4, and −0.5≤z≤0.1. M may be a lithium-nickel metal oxide and may include Co, Mn, and/or Al.

The chemical structure represented by Chemical formula 1 indicates a bonding relationship included in the layered structure or the crystal structure of the positive electrode active material, and does not exclude other additional elements. For example, M may include Co and/or Mn, and Co and/or Mn may be provided as the main active element of the positive electrode active material together with Ni. Chemical formula 1 is provided to express the bonding relationship between the main active elements and should be understood as encompassing the substitution and introduction of additional elements.

In an embodiment, in addition to the main active elements, auxiliary elements configured to enhance chemical stability of the positive electrode active material or the layered/crystal structure may be further included. The auxiliary element may be incorporated into the layered/crystal structure to form a bond, and this case should also be understood as falling within the scope of the chemical structure represented by Chemical formula 1.

The auxiliary element may include, for example, at least one of sodium (Na), magnesium (Mg), calcium (Ca), yttrium (Y), titanium (Ti), hafnium (Hf), vanadium (V), niobium (Nb), tantalum (Ta), chromium (Cr), molybdenum (Mo), tungsten (W), iron (Fe), copper (Cu), silver (Ag), zinc (Zn), boron (B), aluminum (Al), gallium (Ga), carbon C, silicon (Si), tin (Sn), strontium (Sr), barium (Ba), radium (Ra), phosphorus (P), or zirconium (Zr).

The auxiliary element may also act as an auxiliary active element contributing to capacity/power activity of the positive electrode active material, for example, together with Co or Mn, like Al.

For example, the positive electrode active material or the lithium-nickel metal oxide may include a layered structure or a crystal structure represented by Chemical formula 2 below.

LiₓNiₐM1_{b1}M2_{b2}O_{2+z} [Chemical formula 2]

In Chemical formula 2, M1 may include Co, Mn, and/or Al. M2 may include the aforementioned auxiliary element. In Chemical formula 2, 0.9≤x≤1.2, 0.6≤a≤0.99, 0.01≤b1+b2≤0.4, and −0.5≤z≤0.1.

The positive electrode active material may further include a coating element or a doping element. For example, elements substantially identical or similar to the aforementioned auxiliary elements may be used as coating elements or doping elements. For example, any one or a combination of two or more of the aforementioned elements may be used as a coating element or a doping element.

The coating element or the doping element may exist on the surface of a lithium-nickel metal oxide particle or may be included in the bonded structure represented by Chemical formula 1 or Chemical formula 2 by penetrating through the surface of a lithium-nickel metal composite oxide particle.

The positive electrode active material may include a nickel-cobalt-manganese (NCM)-based lithium oxide. In this case, an NCM-based lithium oxide with increased nickel content may be used.

Ni may be provided as a transition metal associated with the output and capacity of a lithium secondary battery. Therefore, as described above, adopting a high-content (High-Ni) composition in the positive electrode active material may enable the provision of a high-capacity positive electrode and a high-capacity lithium secondary battery.

However, as the content of Ni increases, long-term storage stability and life stability of the positive electrode or the secondary battery may relatively decrease, and side reactions with the electrolyte may also increase. According to exemplary embodiments, however, it is possible to maintain electrical conductivity by including Co and to improve cycle life stability and capacity retention characteristics through Mn.

The content of Ni in the NCM-based lithium oxide (e.g., the molar fraction of nickel in the total moles of nickel, cobalt, and manganese) may be 0.6 or more, 0.7 or more, or 0.8 or more. In some embodiments, the content of Ni may be 0.8 to 0.95, 0.82 to 0.95, 0.83 to 0.95, 0.84 to 0.95, 0.85 to 0.95, or 0.88 to 0.95.

In some embodiments, the positive electrode active material may include a lithium cobalt oxide-based active material, a lithium manganese oxide-based active material, a lithium nickel oxide-based active material, or a lithium iron phosphate (LFP)-based active material (e.g., LiFePO₄).

In some embodiments, the positive electrode active material may include an Mn-rich-based active material, an Li-rich layered oxide (LLO)/over-lithiated oxide (OLO)-based active material, or a Co-less-based active material having a chemical structure or a crystal structure represented, for example, by Chemical formula 3.

p[Li₂MnO₃]·(1−p)[Li_{q}JO₂] [Chemical formula 3]

In Chemical formula 3, 0<p<1, 0.9≤q≤1.2, and J may include at least one of Mn, Ni, Co, Fe, Cr, V, Cu, Zn, Ti, Al, Mg, and B.

Meanwhile, electrode density may refer to the content of the active material in the electrode expressed as mass per unit volume. In order to increase the electrode density, a method of compressing an electrode specimen to increase density thereof through a rolling process may be used. In the rolling process, the electrode is compressed under a certain pressure to adjust the thickness of the electrode, thereby increasing the density of the electrode by reducing voids in the electrode, and thus improving the mechanical properties of the electrode. For electrodes with the same electrode density, a smaller electrode thickness means less active material, which may improve flexibility of the electrode.

According to an embodiment of the present disclosure, the thickness of the electrode may be, for example, 50 to 200 μm, 50 to 180 μm, 50 to 150 μm, 50 to 120 μm, 50 to 100 μm, 80 to 200 μm, 80 to 180 μm, 80 to 160 μm, 80 to 120 μm, 80 to 100 μm, 100 to 200 μm, 100 to 180 μm, 100 to 160 μm, 100 to 150 μm, 100 to 140 μm, 100 to 120 μm, 120 to 200 μm, 120 to 180 μm, 120 to 160 μm, 120 to 150 μm, 120 to 140 μm, 130 to 200 μm, 130 to 180 μm, 130 to 150 μm, 200 μm or less, 150 μm or less, 100 μm or less, 90 μm or less, 80 μm or less, 70 μm or less, 60 μm or less, or 50 μm or less, but the present disclosure is not limited thereto.

Increasing rolling density may increase the content of the active material in the electrode, thereby increasing the energy capacity of the secondary battery. However, excessively high rolling density may reduce the flexibility of the electrode and may cause cracks or fissures in the electrode due to mechanical stress generated during the winding process.

The electrode density of the positive electrode active material may refer to the value representing the electrode including the positive electrode active material as mass per unit volume. High electrode density of the positive electrode active material may increase the content of the active material at the same volume, thereby increasing the energy capacity of the secondary battery. However, excessively high electrode density may reduce internal porosity, thereby diminishing flexibility of the electrode, and may easily cause electrode damage (cracks, fissures, etc.) due to mechanical stress generated during the winding process.

According to an embodiment of the present disclosure, the electrode density of the positive electrode active material may be, for example, 3 g/cm³ or more, 3.2 g/cm³ or more, 3.4 g/cm³ or more, 3.6 g/cm³ or more, 3.8 g/cm³ or more, or 4.0 g/cm³ or more, but the present disclosure is not limited thereto.

The electrode mixture layer of the electrode for secondary batteries according to the embodiment of the present disclosure may be divided into a first region extending a predetermined length from a winding start end in a winding direction and a second region extending from the first region to a winding termination end. Each of the first region and the second region includes an active material, a conductive agent, and a binder.

In addition, the first region and the second region of the electrode mixture layer may include binders with different contents, or the first region and the second region may include different types of binders. Consequently, the electrode mixture layer may be divided into two regions such that the first region has higher ductility than the second region. The content may refer to wt % (weight %).

In the electrode for secondary batteries according to the embodiment of the present disclosure, the ductility of the first region may higher than that of the second region, and therefore it is possible to effectively suppress cracks and fissures that readily occur during a manufacturing process of a high-capacity secondary battery with high electrode density.

According to an embodiment of the present disclosure, the binder included in the positive electrode mixture layer may include, for example, polyvinylidene fluoride (PVDF), poly(vinylidene fluoride-co-hexafluoropropylene), polyacrylonitrile, polymethyl methacrylate, nitrile butadiene rubber (NBR), hydrogenated nitrile butadiene rubber (HNBR), polybutadiene rubber (BR), or styrene-butadiene rubber (SBR). In an embodiment, a PVDF-based binder may be used as the positive electrode binder.

Each of the first region and the second region of the electrode mixture layer according to the embodiment of the present disclosure may include 93.5 to 97.5 wt % of an active material, 1 to 3 wt % of a conductive agent, and 0.5 to 3.5 wt % of a binder.

The content of the active material included in each of the first region and the second region according to the embodiment of the present disclosure may be, for example, 93.5 to 97.5 wt %, 94 to 97 wt %, 93.5 to 97 wt %, 94.5 to 97 wt %, 94 to 96.5 wt %, 94 to 96 wt %, 94.5 to 96.5 wt %, 94.5 to 96 wt %, or 94.5 to 95.5 wt % based on the total weight of the electrode mixture layer in each region, but the present disclosure is not limited thereto. The content of the active material may be appropriately adjusted according to the combined weight of the conductive agent and the binder based on the total weight of the electrode mixture layer.

The content of the conductive agent included in each of the first region and the second region according to the embodiment of the present disclosure may be, for example, 1 to 3 wt %, 1.5 to 2.5 wt %, 1 to 2.5 wt %, 1.5 to 2 wt %, 2 to 2.5 wt %, or 2 to 3 wt % based on the total weight of the electrode mixture layer of each region, but the present disclosure is not limited thereto.

Meanwhile, in an exemplary embodiment, the regions may include the same type of active material and conductive agent, but the present disclosure is not limited thereto.

According to an embodiment of the present disclosure, the content of the binder included in the second region may be 2 wt % or less of the total weight of the electrode mixture layer in the second region. The content of the binder included in the second region may be, for example, 2 wt % or less, 1.9 wt % or less, 1.8 wt % or less, 1.7 wt % or less, 1.6 wt % or less, 1.5 wt % or less, 1.4 wt % or less, 1.3 wt % or less, 1.2 wt % or less, 1.1 wt % or less, or 1.0 wt % or less, 0.9 wt % or less, 0.8 wt % or less, 0.7 wt % or less, 0.5 wt % or less, 0.4 wt % or less, 0.3 wt % or less, 0.2 wt % or less, or 0.1 wt % or less of the total weight of the electrode mixture layer, but the present disclosure is not limited thereto.

According to an embodiment of the present disclosure, the first region and the second region may include binders of different contents, and the content of the binder in the first region may be higher than that of the binder in the second region. According to an exemplary embodiment, the content of the binder included in the first region may be 1.1 to 10 times that of the binder included in the second region, but the present disclosure is not limited thereto. For example, wt % of the binder in the first region may be 1.1 to 10 times, 1.1 to 9 times, 1.1 to 8 times, 1.1 to 7 times, 1.1 to 6 times, 1.1 to 5 times, 1.1 to 4 times, 1.1 to 3 times, 1.1 to 2 times, 2 to 8 times, 2 to 6 times, 2 to 4 times, or 2 to 3 times wt % of the binder in the second region, but the present disclosure is not limited thereto. According to an exemplary embodiment, if 1.5 wt % of the binder is included in the second region, 3 wt % of the binder may be included in the first region. In this case, the binder in the first region and the binder in the second region may be the same type of binder or different types of binders. Increasing the content of the binder in the first region may improve flexibility of the electrode, and therefore it is possible to effectively prevent cracks or fissures in the electrode that may occur during the winding process while minimizing the content of the binder included in the second region. Consequently, it is possible to increase the content of the active material by minimizing the total amount of the binder included in the entire electrode, and therefore it is possible to improve the capacity and power characteristics of the electrode while simultaneously reducing the potential for damage during the winding process, thereby enhancing the electrode preparation yield.

Increasing the content of the binder in the electrode mixture layer may allow external stress or deformation to be dispersed and mitigated over a wider area, whereby it is possible to enhance flexibility and tensile elongation of the electrode mixture layer. Consequently, even when the content of the binder is increased, the potential for electrode damage during the winding process may be reduced.

According to an embodiment of the present disclosure, the first region and the second region may include different types of binders. Different types of binders may mean that different types of single binders and/or different types of mixed binders are included in the first region and the second region. A mixed binder may refer to a binder in a state in which one or more different types of binders are uniformly mixed. According to an embodiment of the present disclosure, the first region may include a binder with higher tensile elongation than the second region such that the ductility of the first region is higher than that of the second region. When a binder with higher tensile elongation is included in the first region in which stress due to winding is concentrated, flexibility of the first region may be improved and mechanical strength of the first region may be enhanced, and therefore the likelihood of cracks or fissures occurring in the electrode during the winding process may be reduced. According to an exemplary embodiment, the tensile elongation of the binder included in the first region may be 100% or more, for example, 100 to 500%, 100 to 400%, 100 to 300%, 100 to 200%, 200 to 500%, 200 to 400%, 200 to 300%, 300 to 500%, 300 to 400%, 150% or more, 200% or more, 250% or more, 300% or more, 350% or more, 400% or more, or 450% or more, but the present disclosure is not limited thereto.

If ductility of the electrode mixture layer is high, the electrode is not easily damaged even when subjected to external stress or repeated deformation such as bending, compression, or tension. That is, the higher the ductility, the more effectively stress (particularly, stress concentrated in a central region with low curvature) generated during the electrode winding process may be dispersed and absorbed, thereby mitigating localized stress concentration. As a result, the likelihood of generation and propagation of cracks or fissures in the electrode decreases. Even with high electrode density and relatively low internal porosity, therefore, the mechanical stability of the electrode may be improved, reducing the risk of damage during secondary battery manufacturing processes.

Meanwhile, if the electrode according to the embodiment of the present disclosure is a negative electrode, the current collector may be a negative electrode current collector, the negative electrode may include a negative electrode mixture layer disposed on at least one surface of the negative electrode current collector, and the negative electrode mixture layer may include a negative electrode active material. A material capable of adsorbing and desorbing lithium ions may be used as the negative electrode active material. For example, a carbon-based material, such as crystalline carbon, amorphous carbon, a carbon composite, or carbon fiber, lithium metal, a lithium alloy, silicon (Si)-containing material, or a tin (Sn)-containing material may be used as the negative electrode active material.

Examples of amorphous carbon may include hard carbon, soft carbon, coke, mesocarbon microbead (MCMB), and mesophase pitch-based carbon fiber (MPCF).

Examples of crystalline carbon may include graphite-based carbon materials, such as natural graphite, artificial graphite, graphitized coke, graphitized MCMB, and graphitized MPCF.

Lithium metal may be pure lithium metal or lithium metal with a protective layer configured to suppress dendrite growth, etc. In an embodiment, a lithium metal-containing layer deposited or coated on the negative electrode collector may be used as the negative electrode active material layer. In an embodiment, a lithium thin film layer may also be used as the negative electrode active material layer.

Elements included in the lithium alloy may include aluminum, zinc, bismuth, cadmium, antimony, silicon, lead, tin, gallium, or indium.

The silicon-containing material may provide increased capacity characteristics. The silicon-containing material may include Si, SiOₓ (0<x<2), metal-doped SiOₓ (0<x<2), or a silicon-carbon composite. The metal may include lithium and/or magnesium, and the metal-doped SiOₓ (0<x<2) may include metal silicate. The negative electrode mixture layer may be prepared through the following process. For example, a negative electrode slurry may be prepared by mixing a negative electrode active material in a solvent, and a negative electrode mixture layer may be prepared by coating a negative electrode current collector with the prepared negative electrode slurry and drying and rolling the same. Coating may be performed using a gravure coating method, a slot die coating method, a multilayer simultaneous die coating method, an imprinting method, a doctor blade coating method, a dip coating method, a bar coating method, or a casting method, but the present disclosure is not limited thereto. The negative electrode mixture layer may further include a binder, and may optionally further include a conductive agent or a thickening agent. The aforementioned materials that can be used to prepare the positive electrode may be used as the binder, the conductive agent, and the thickening agent. Non-limiting examples of the solvent for negative electrode mixture may include water, pure water, deionized water, distilled water, ethanol, isopropanol, methanol, acetone, n-propanol, and t-butanol.

In some embodiments, the negative electrode may include a negative electrode active material layer in the form of lithium metal formed through a deposition/coating process.

According to an embodiment of the present disclosure, a styrene-butadiene rubber (SBR)-based binder, carboxymethyl cellulose (CMC), a polyacrylic acid-based binder, or a poly(3,4-ethylenedioxythiophene) (PEDOT)-based binder may be used as the binder included in the negative electrode mixture layer.

Hereinafter, the present disclosure will be described in detail with reference to the accompanying drawings. However, this is merely illustrative and the present disclosure is not limited to a specific embodiment described by way of example. Meanwhile, in the drawings, the depiction of each component may be exaggerated or omitted for the sake of convenience and clarity of explanation.

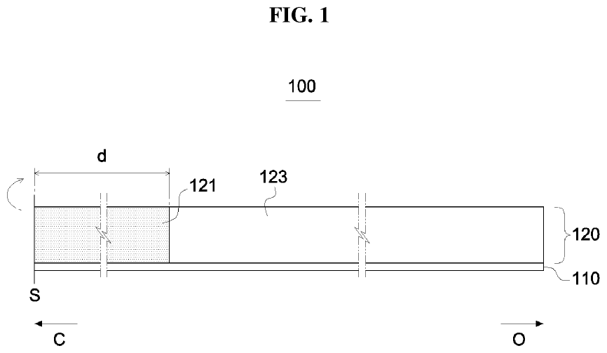

FIG. 1 is a schematic view showing an electrode for secondary batteries according to an embodiment before winding.

Referring to FIG. 1, the electrode 100 for secondary batteries according to the embodiment of the present disclosure includes a current collector 110 and an electrode mixture layer 120 disposed on at least one surface of the current collector 110.

The electrode mixture layer 120 according to the embodiment of the present disclosure is divided into a first region 121 extending a predetermined length from a winding start end S in a winding direction and a second region 123 extending from the first region 121 to a winding termination end.

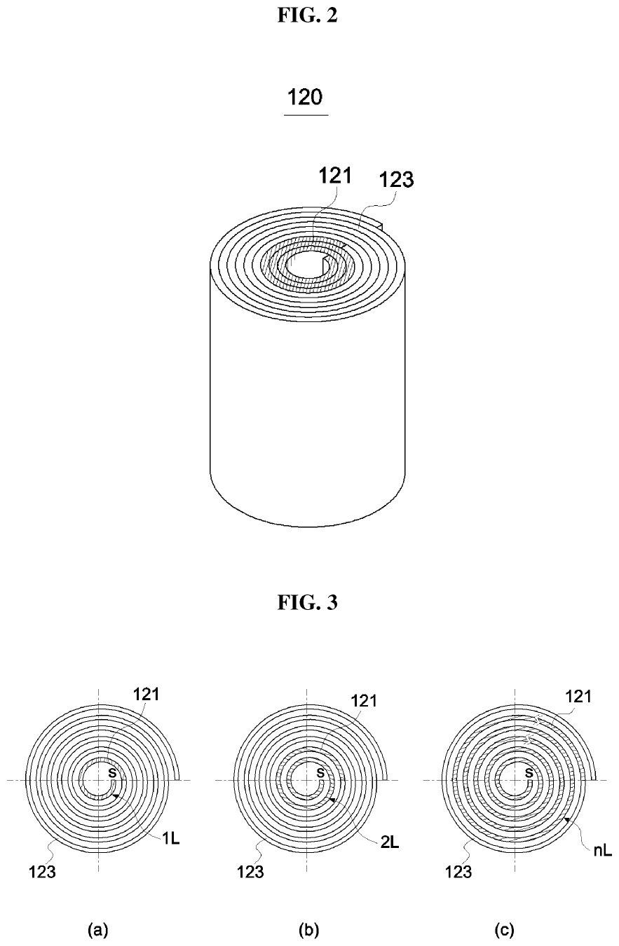

FIG. 2 is a schematic view showing only the electrode mixture layer included in the electrode for secondary batteries according to the embodiment after winding, and FIG. 3 is a sectional view of the electrode for secondary batteries according to the embodiment after winding when cut in a direction perpendicular to an axial direction of a core member, showing the positional relationship between the first region and the second region and the length of the first region based on the winding start end.

Upon completion of winding the electrode 100 for secondary batteries of FIG. 1, the electrode has a cylindrical shape, as shown in FIG. 2. During winding, a winding start end S is located at a core portion C of the cylindrical electrode, and a first region 121 is also wound from the winding start end S by a predetermined length extending toward an outer edge O in a winding direction.

As the electrode is wound from the winding start end S, the electrode surrounds the circumference of a core member (not shown) by 360°. At this time, the length d of the first region may be determined based on the outer diameter of the core member, the thickness of the electrode, and the number of windings of the electrode located inside. On the assumption that the core member is formed in the shape of a cylinder, the circumference of the core member refers to the circumference of a circle constituting the section of the cylinder when the cylinder is cut in a horizontal direction. Although the diameter of the core member is not particularly limited, the diameter of a core member according to a specific embodiment of the present disclosure may be, for example, 0.5 to 8 mm, 0.5 to 7.5 mm, 0.5 to 6 mm, 0.5 to 5.5 mm, 0.5 to 5 mm, 0.5 to 4 mm, 0.5 to 3 mm, 1 to 8 mm, 1 to 6 mm, 1 to 4 mm, 1 to 2 mm, 2 to 8 mm, 2 to 6 mm, 2 to 4 mm, 4 to 8 mm, 4 to 6 mm, or 5 to 7 mm.

According to an embodiment of the present disclosure, the length d of the first region may be the region in which the electrode is wound 1 to 10 times from the winding start end S in the winding direction. The winding direction may be a clockwise direction or a counterclockwise direction when viewed from above.

Referring to FIG. 3, the electrode according to the embodiment of the present disclosure may be wound helically from the winding start end S. The number of windings is based on the electrode rotating 360° from the winding start end S and being located on the same line as the winding start end S. Therefore, if the first region 121 is defined as one full spiral rotation from the winding start end S in the winding direction (clockwise direction), as shown in FIG. 3(a), the length d of the first region is defined as 1L. If the first region 121 is defined as two full rotations, as shown in FIG. 3(b), the length d of the first region may be defined as 2 L. If the first region 121 is defined as n full rotations, as shown in FIG. 3(c), the length d of the first region may be defined as nL. Accordingly, the region in which the electrode is wound 1 to 10 times may mean the region in which the electrode is wound 1 to 10 times from the winding start end S in the winding direction and the length d of the first region 121 corresponds to 1 L to 10 L.

Meanwhile, the length d of the first region 121 of the electrode according to the embodiment of the present disclosure may be, for example, 80 to 400 mm, 100 to 380 mm, 120 to 360 mm, 140 to 340 mm, 160 to 320 mm, 180 to 300 mm, 90 to 380 mm, 90 to 360 mm, 90 to 340 mm, or 90 to 320 mm, but the present disclosure is not limited thereto.

The electrode assembly according to the embodiment of the present disclosure is rechargeable, and may include a positive electrode, a negative electrode, and a separator. The positive electrode may be the electrode described above. The separator may be located between the positive electrode and the negative electrode, or may be located on any one of one surface of the positive electrode and one surface of the negative electrode.

The electrode assembly may be formed through a winding process of helically winding the electrodes (the positive electrode and the negative electrode) and the separator around a core member. The electrode assembly may be a jelly-roll structure in which the positive electrode, the separator, and the negative electrode are sequentially stacked before winding and are then wound around the core member as the winding axis. When the core member is removed after the positive electrode, the negative electrode, and the separator are wound around the core member, a hollow space (an empty space) may be formed in the center (core) of the electrode assembly.

In the electrode for secondary batteries according to the embodiment of the present disclosure, it is possible to minimize the total content of the binder included in the electrode by increasing the content of the binder only in a part of the electrode (e.g., the first region 121) and/or by using a binder with high flexibility. Specifically, it is possible to reduce unnecessary binder usage while maintaining the mechanical stability of the electrode by applying a different binder composition such that only a local region (e.g., the region 121) requiring the mechanical bonding strength and stress dispersion characteristics of the binder exhibits increased ductility. It is possible to increase the proportion of the active material in the electrode by minimizing the content of the binder included in the electrode in this manner. This means more active material can be included in the same electrode area or volume, which consequently increases the lithium-ion storage capacity of the electrode and can contribute to improving the energy density of the secondary battery. In addition, reducing the content of the binder may increase the direct electrical contact area between the active material and the conductive agent, enhancing electrochemical reaction activity and contributing to improved capacity characteristics of the electrode.

Moreover, as the part of the binder acting as an electrical insulator decreases, a conductive path in the electrode may be formed more efficiently, whereby internal resistance of the electrode may be reduced. This may enhance electron transfer efficiency in the electrode and consequently act as a factor providing high output performance to the electrode.

Consequently, in the electrode according to the embodiment of the present disclosure, it is possible to minimize the content of the binder through selective application of the binder, and therefore it is possible to provide the effect of simultaneously improving the energy density and output characteristics of the electrode while maintaining the mechanical stability of the electrode.

A battery cell according to an embodiment of the present disclosure may include the electrode assembly.

A battery module according to an embodiment of the present disclosure may include one or more battery cells. The battery cell may be the battery cell according to the embodiment of the present disclosure.

A battery pack according to an embodiment of the present disclosure may include one or more battery cells or one or more battery modules. The battery cell may be the battery cell according to the embodiment of the present disclosure, and the battery module may be the battery module according to the embodiment of the present disclosure. The battery pack may have a structure equipped with various control devices and protection systems, such as a battery management system (BMS) and a cooling device. Meanwhile, the battery pack may have a cell-to-pack structure in which the battery pack is constituted by the battery cells rather than the battery modules.

An electrical device according to an embodiment of the present disclosure may include at least one selected from the group consisting of one or more battery cells, one or more battery modules, and one or more battery packs. The battery cell, the battery module, and the battery pack may be the battery cell, the battery module, and the battery pack according to the embodiments of the present disclosure. The electrical device may refer to a device operated by power generated from the battery cell, etc., and may be, for example, a mobile phone, a home appliance, an electric vehicle, a hybrid vehicle, or an energy storage system (ESS).

Hereinafter, examples of the present disclosure will be further described with reference to specific experimental examples. Examples and comparative examples included in the experimental examples are merely illustrative of the present disclosure and do not limit the appended claims. It is obvious to those skilled in the art that various changes and modifications to the embodiments are possible within the scope and the technical concept of the present disclosure and such changes and modifications also fall within the scope of the appended claims.

### Experimental Example 1

PVDF (tensile elongation of 200%) was selected as a first binder, HNBR (tensile elongation of 300%) was selected as a second binder, and a binder included in a first region (hereinafter referred to as a first region binder) and a binder included in a second region (hereinafter referred to as a second region binder) were prepared according to the compositions shown in Table 1 below. Each electrode was prepared according to the compositions shown in Table 1 below using carbon nanotubes (CNT) as a conductive agent and Li[Ni_{0.8}Co_{0.1}Mn_{0.1}]O₂ as a positive electrode active material. Meanwhile, the terms “first binder” and “second binder” are merely designations for classifying binder types and should not be interpreted as designating or limiting binders included in specific regions.

Specifically, the first region binder was added to N-methyl-2-pyrrolidone (NMP), which is a solvent, together with the conductive agent and the positive electrode active material to prepare a first positive electrode active material slurry, and the second region binder was added to NMP, which is a solvent, together with the conductive agent and the positive electrode active material to prepare a second positive electrode active material slurry.

Aluminum foil was uniformly coated with the prepared first positive electrode active material slurry from a winding start end up to 100 mm, the region exceeding 100 mm was uniformly coated with the second positive electrode active material slurry, and drying was performed at 100° C. for 3 hours to prepare a positive electrode. After coating, the positive electrode was pressed so as to have a density of 3.7 g/cm³.

TABLE 1

| | First region of electrode | | | | Second region of electrode | | | | |
|---|---|---|---|---|---|---|---|---|---|
| | First region | | | Positive | Second region | | | Positive | Length |
| | binder wt % | | Con- | electrode | binder wt % | | Con- | electrode | of |
| | First | Second | ductive | active | First | Second | ductive | active | first |
| | binder | binder | agent | material | binder | binder | agent | material | region |
| | (PVDF) | (HNBR) | wt % | wt % | (PVDF) | (HNBR) | wt % | wt % | (mm) |
| Example | 0 | 1.5 | 2.0 | 96.5 | 1.5 | 0 | 2.0 | 96.5 | 100 |
| 1-1 | | | | | | | | | |
| Com- | 1.5 | 0 | 2.0 | 96.5 | 1.5 | 0 | 2.0 | 96.5 | 100 |
| parative | | | | | | | | | |
| example | | | | | | | | | |
| 1-1 | | | | | | | | | |

A bending test and a 6ø rod winding evaluation were conducted on each electrode prepared according to the compositions in Table 1 above. The bending test was performed using a MIT folding endurance tester (YASUIDA SEIIKI SEISAKUSHO, LTD.), and the number of times that the electrode was bent 90° until the electrode fractured was measured. The 6ø rod winding evaluation was performed using a 6ø cylindrical rod, the fissure of the electrode was evaluated based on whether a lower end of the electrode broke during winding of the electrode. The evaluation results are shown in Table 2 below.

TABLE 2

| | | | | | | | MIT |
|---|---|---|---|---|---|---|---|
| | First region | | Second region | | | | folding |
| | binder wt % | | binder wt % | | Length | | endurance |
| | First | Second | First | Second | of first | 6ø rod | evaluation |
| | binder | binder | binder | binder | region | winding | (number |
| | (PVDF) | (HNBR) | (PVDF) | (HNBR) | (mm) | evaluation | of times) |
| Example 1-1 | 0 | 1.5 | 1.5 | 0 | 100 | Good | 197 |
| Comparative | 1.5 | 0 | 1.5 | 0 | 100 | Fracture | 34 |
| example 1-1 | | | | | | | |

Referring to the results in Table 2 above, when the composition of the first region binder and the composition of the second region binder are the same, as in the electrode of Comparative example 1-1, electrode breakage occurred. However, when a binder (HNBR) with a higher tensile elongation than the second region binder (PVDF) was used as the first region binder, as in the electrode of Example 1-1, both the winding evaluation results and the folding endurance evaluation results were found to be favorable. In light of these results, it was confirmed that, even when the binder is included at a low content (1.5 wt % per region), using a binder with higher ductility (tensile elongation) in the first region reduces the likelihood of cracks or fissures occurring in the electrode.

### Experimental Example 2

In order to confirm that the ductility of an electrode is superior when a binder with a higher content is included, a comparative experiment was conducted as follows.

A positive electrode was prepared in the same manner as in Experimental example 1, except for selecting PVDF as a first binder and preparing a first region binder and a second region binder according to the compositions shown in Table 3 below.

TABLE 3

| | First region of electrode | | | Second region of electrode | | | |
|---|---|---|---|---|---|---|---|
| | First | | | Second | | | |
| | region | | | region | | | |
| | binder | | Positive | binder | | Positive | Length |
| | wt % | Con- | electrode | wt % | Con- | electrode | of |
| | First | ductive | active | First | ductive | active | first |
| | binder | agent | material | binder | agent | material | region |
| | (PVDF) | wt % | wt % | (PVDF) | wt % | wt % | (mm) |
| Example 2-1 | 3.0 | 2.0 | 95.0 | 1.5 | 2.0 | 96.5 | 100 |
| Example 2-2 | 2.5 | 2.0 | 95.5 | 1.5 | 2.0 | 96.5 | 100 |
| Example 2-3 | 2.0 | 2.0 | 96.0 | 1.5 | 2.0 | 96.5 | 100 |
| Comparative | 1.5 | 2.0 | 96.5 | 1.5 | 2.0 | 96.5 | |
| example 2-1 | | | | | | | 100 |
| Comparative | 1.0 | 2.0 | 97.0 | 1.5 | 2.0 | 96.5 | 100 |
| example 2-2 | | | | | | | |

A bending test and a 6ø rod winding evaluation were conducted on each electrode prepared according to the compositions in Table 3 above. The evaluation results are shown in Table 4 below.

TABLE 4

| | First | Second | | | |
|---|---|---|---|---|---|
| | region | region | | | MIT |
| | binder | binder | | | folding |
| | wt % | wt % | Length | | endurance |
| | First | First | of first | 6ø rod | evaluation |
| | binder | binder | region | winding | (number of |
| | (PVDF) | (PVDF) | (mm) | evaluation | times) |
| Example 2-1 | 3.0 | 1.5 | 100 | Good | 322 |
| Example 2-2 | 2.5 | 1.5 | 100 | Good | 263 |
| Example 2-3 | 2.0 | 1.5 | 100 | Good | 197 |
| Comparative | 1.5 | 1.5 | 100 | Fracture | 34 |
| example 2-1 | | | | | |
| Comparative | 1.0 | 1.5 | 100 | Fracture | 11 |
| example 2-2 | | | | | |

Referring to the results in Table 4 above, when the content (wt %) of the first region binder was higher than that of the second region binder, no fracture occurred in the electrode, and the folding endurance evaluation also showed generally favorable results. In light of these results, it was confirmed that the electrode for secondary batteries according to the embodiment of the present disclosure, having a higher content of the first region binder, exhibits excellent ductility and durability.

### Experimental Example 3

In order to confirm that stability of the electrode is secured when the length of the first region is 90 mm or more, a comparative experiment was performed as follows.

A positive electrode was prepared in the same manner as in Experimental example 1, except that PVDF was selected as a first binder, a first region binder and a second region binder were prepared according to the compositions as shown in Table 5 below, and aluminum foil was uniformly coated with a first positive electrode active material slurry up to 10 mm, 25 mm, 50 mm, 75 mm, 90 mm, 200 mm, and 300 mm from a winding start point.

TABLE 5

| | First region of electrode | | | Second region of electrode | | | |
|---|---|---|---|---|---|---|---|
| | First | | | Second | | | |
| | region | | | region | | | |
| | binder | | Positive | binder | | Positive | Length |
| | wt % | Con- | electrode | wt % | Con- | electrode | of |
| | First | ductive | active | First | ductive | active | first |
| | binder | agent | material | binder | agent | material | region |
| | (PVDF) | wt % | wt % | (PVDF) | wt % | wt % | (mm) |
| Example 2-1 | 3.0 | 2.0 | 95.0 | 1.5 | 2.0 | 96.5 | 100 |
| Example 2-4 | 3.0 | 2.0 | 95.0 | 1.5 | 2.0 | 96.5 | 90 |
| Example 2-5 | 3.0 | 2.0 | 95.0 | 1.5 | 2.0 | 96.5 | 200 |
| Example 2-6 | 3.0 | 2.0 | 95.0 | 1.5 | 2.0 | 96.5 | 300 |
| Comparative | 3.0 | 2.0 | 95.0 | 1.5 | 2.0 | 96.5 | 10 |
| example 2-3 | | | | | | | |
| Comparative | 3.0 | 2.0 | 95.0 | 1.5 | 2.0 | 96.5 | 25 |
| example 2-4 | | | | | | | |
| Comparative | 3.0 | 2.0 | 95.0 | 1.5 | 2.0 | 96.5 | 50 |
| example 2-5 | | | | | | | |
| Comparative | 3.0 | 2.0 | 95.0 | 1.5 | 2.0 | 96.5 | 75 |
| example 2-6 | | | | | | | |

A bending test and a 6ø rod winding evaluation were conducted on each electrode prepared according to the compositions in Table 5 above. The evaluation results are shown in Table 6 below.

TABLE 6

| | First | Second | | | |
|---|---|---|---|---|---|
| | region | region | | | MIT |
| | binder | binder | | | folding |
| | wt % | wt % | | | endurance |
| | First | First | Length | 6ø rod | evaluation |
| | binder | binder | of first | winding | (number of |
| | (PVDF) | (PVDF) | region(mm) | evaluation | times) |
| Example 2-1 | 3.0 | 1.5 | 100 | Good | 322 |
| Example 2-4 | 3.0 | 1.5 | 90 | Good | 329 |
| Example 2-5 | 3.0 | 1.5 | 200 | Good | 316 |
| Example 2-6 | 3.0 | 1.5 | 300 | Good | 327 |
| Comparative | 3.0 | 1.5 | 10 | Fracture | 7 |
| example 2-3 | | | | | |
| Comparative | 3.0 | 1.5 | 25 | Fracture | 220 |
| example 2-4 | | | | | |
| Comparative | 3.0 | 1.5 | 50 | Fracture | 270 |
| example 2-5 | | | | | |
| Comparative | 3.0 | 1.5 | 75 | Fracture | 303 |
| example 2-6 | | | | | |

Referring to the results in Table 6 above, when the length of the first region was 90 mm or more, no fracture occurred in the electrode, and the folding endurance evaluation also showed generally favorable results. In light of these results, it was confirmed that the length of the first region according to the embodiment of the present disclosure is preferably 90 mm or more.

### Experimental Example 4

In order to confirm that, when a second binder (HNBR) with high ductility (tensile elongation) is mixed with a first binder (PVDF), ductility of an electrode is superior, a comparative experiment was conducted as follows.

A positive electrode was prepared in the same manner as in Experimental example 1, except for selecting PVDF as a first binder, selecting HNBR as a second binder, and preparing a first region binder and a second region binder according to the compositions shown in Table 7 below.

TABLE 7

| | | | | | Second region of electrode | | | |
|---|---|---|---|---|---|---|---|---|
| | | | | | Second | | | |
| | First region of electrode | | | | region | | | |
| | First region | | | Positive | binder | | Positive | Length |
| | binder wt % | | Con- | electrode | wt % | Con- | electrode | of |
| | First | Second | ductive | active | First | ductive | active | first |
| | binder | binder | agent | material | binder | agent | material | region |
| | (PVDF) | (HNBR) | wt % | wt % | (PVDF) | wt % | wt % | (mm) |
| Example | 1.5 | 2.0 | 2.0 | 94.5 | 1.5 | 2.0 | 96.5 | 100 |
| 3-1 | | | | | | | | |
| Example | 1.5 | 1.5 | 2.0 | 95.0 | 1.5 | 2.0 | 96.5 | 100 |
| 3-2 | | | | | | | | |
| Example | 1.5 | 1.0 | 2.0 | 95.5 | 1.5 | 2.0 | 96.5 | 100 |
| 3-3 | | | | | | | | |
| Example | 1.5 | 0.5 | 2.0 | 96.0 | 1.5 | 2.0 | 96.5 | 100 |
| 3-4 | | | | | | | | |
| Example | 0 | 2.5 | 2.0 | 95.5 | 1.5 | 2.0 | 96.5 | 100 |
| 3-5 | | | | | | | | |
| Example | 1.0 | 1.5 | 2.0 | 95.5 | 1.5 | 2.0 | 96.5 | 100 |
| 3-6 | | | | | | | | |

A bending test and a 6ø rod winding evaluation were conducted on each electrode prepared according to the compositions in Table 7 above. The evaluation results are shown in Table 8 below.

TABLE 8

| | | | Second | | | |
|---|---|---|---|---|---|---|
| | | | region | | | MIT |
| | First region | | binder | Length | | folding |
| | binder wt % | | wt % | of | | endurance |
| | First | Second | First | first | 6ø rod | evaluation |
| | binder | binder | binder | region | winding | (number |
| | (PVDF) | (HNBR) | (PVDF) | (mm) | evaluation | of times) |
| Example | 1.5 | 2.0 | 1.5 | 100 | Good | 437 |
| 3-1 | | | | | | |
| Example | 1.5 | 1.5 | 1.5 | 100 | Good | 391 |
| 3-2 | | | | | | |
| Example | 1.5 | 1.0 | 1.5 | 100 | Good | 342 |
| 3-3 | | | | | | |
| Example | 1.5 | 0.5 | 1.5 | 100 | Good | 243 |
| 3-4 | | | | | | |
| Example | 0 | 2.5 | 1.5 | 100 | Good | 486 |
| 3-5 | | | | | | |
| Example | 1.0 | 1.5 | 1.5 | 100 | Good | 337 |
| 3-6 | | | | | | |

Referring to the results in Table 8 above, it was confirmed that, even when the first binder (PVDF) was used as the second region binder and a binder (HNBR+PVDF) prepared by mixing the second binder and the first binder with each other was used as the first region binder, no fracture occurred in the electrode, and the folding endurance evaluation also showed generally favorable results.

According to Table 8, it was confirmed that the mixed binder (HNBR+PVDF), obtained by mixing the second binder (HNBR) with superior flexibility and durability and the first binder (PVDF), also exhibits higher flexibility and durability than the first binder (PVDF). In particular, it was confirmed that, as the content (wt %) of the second binder (HNBR) was increased, superior folding endurance evaluation results were obtained.

In light of these results, it was confirmed that the electrode for secondary batteries according to the embodiment of the present disclosure using the binder composition with excellent flexibility and durability for the first region binder exhibits excellent ductility and durability.

### Experimental Example 5

In order to confirm that stability of an electrode is secured when the length of a first region is 90 mm or more, a comparative experiment was performed as follows.

A positive electrode was prepared in the same manner as in Experimental example 1, except that PVDF was selected as a first binder, HNBR was selected as a second binder, a first region binder and a second region binder were prepared according to the compositions as shown in Table 9 below, and aluminum foil was uniformly coated with a first positive electrode active material slurry up to 50 mm, 75 mm, 90 mm, 200 mm, and 300 mm from a winding start point.

TABLE 9

| | | | | | Second region of electrode | | | |
|---|---|---|---|---|---|---|---|---|
| | | | | | Second | | | |
| | First region of electrode | | | | region | | | |
| | First region | | | Positive | binder | | Positive | Length |
| | binder wt % | | Con- | electrode | wt % | Con- | electrode | of |
| | First | Second | ductive | active | First | ductive | active | first |
| | binder | binder | agent | material | binder | agent | material | region |
| | (PVDF) | (HNBR) | wt % | wt % | (PVDF) | wt % | wt % | (mm) |
| Example | 1.5 | 2.0 | 2.0 | 94.5 | 1.5 | 2.0 | 96.5 | 100 |
| 3-1 | | | | | | | | |
| Example | 1.5 | 2.0 | 2.0 | 94.5 | 1.5 | 2.0 | 96.5 | 90 |
| 3-7 | | | | | | | | |
| Example | 1.5 | 2.0 | 2.0 | 94.5 | 1.5 | 2.0 | 96.5 | 200 |
| 3-8 | | | | | | | | |
| Example | 1.5 | 2.0 | 2.0 | 94.5 | 1.5 | 2.0 | 96.5 | 300 |
| 3-9 | | | | | | | | |
| Comparative | 1.5 | 2.0 | 2.0 | 94.5 | 1.5 | 2.0 | 96.5 | 50 |
| example 3-1 | | | | | | | | |
| Comparative | 1.5 | 2.0 | 2.0 | 94.5 | 1.5 | 2.0 | 96.5 | 75 |
| example | | | | | | | | |
| 3-2 | | | | | | | | |

A bending test and a 6ø rod winding evaluation were conducted on each electrode prepared according to the compositions in Table 9 above. The evaluation results are shown in Table 10 below.

TABLE 10

| | | | | | | MIT |
|---|---|---|---|---|---|---|
| | | | Second | | | folding |
| | | | region | | | endur- |
| | First region | | binder | Length | | ance |
| | binder wt % | | wt % | of | 6ø rod | eval- |
| | First | Second | First | first | winding | uation |
| | binder | binder | binder | region | eval- | (number |
| | (PVDF) | (HNBR) | (PVDF) | (mm) | uation | of times) |
| Example 3-1 | 1.5 | 2.0 | 1.5 | 100 | Good | 437 |
| Example 3-7 | 1.5 | 2.0 | 1.5 | 90 | Good | 405 |
| Example 3-8 | 1.5 | 2.0 | 1.5 | 200 | Good | 421 |
| Example 3-9 | 1.5 | 2.0 | 1.5 | 300 | Good | 412 |
| Comparative | 1.5 | 2.0 | 1.5 | 50 | Fracture | 352 |
| example 3-1 | | | | | | |
| Comparative | 1.5 | 2.0 | 1.5 | 75 | Fracture | 379 |
| example 3-2 | | | | | | |

Referring to the results in Table 10 above, when the length of the first region was 90 mm or more, no fracture occurred in the electrode, and the folding endurance evaluation also showed generally favorable results. In light of these results, it was confirmed that the length of the first region according to the embodiment of the present disclosure is preferably 90 mm or more.

Summarizing the results from the above experimental examples, it was confirmed that including a binder with a higher content in the first region binder and/or including a binder with high ductility (tensile elongation) in the first region binder resulted in the preparation of an electrode with excellent ductility and durability even after winding. Furthermore, it was confirmed that the stability of the electrode is secured when the length of the first region is 90 mm or more.

As is apparent from the above description, according to an embodiment of the present disclosure, it is possible to reduce damage to electrodes that may occur during a secondary battery manufacturing process.

In addition, according to an embodiment of the present disclosure, it is possible to improve the electrode assembly performance and the electrode process yield.

In addition, according to an embodiment of the present disclosure, it is possible to increase the output and capacity of an electrode for secondary batteries.

In addition, according to an embodiment of the present disclosure, it is possible to provide a battery cell, a battery module, and a battery pack including the electrode and to provide an electrical device including at least one of the battery cell, the battery module, and the battery pack.

However, the technical effects obtainable through the embodiments of the present disclosure are not necessarily limited to those mentioned above. Other unmentioned technical effects will be clearly understood by those skilled in the art from other parts of the specification, such as the detailed description.

The above description is merely an example of applying the principles of the present disclosure, and other configurations may be further included without departing from the scope of the present disclosure.

Although embodiments of the present disclosure have been described above, those skilled in the art will recognize that various modifications or changes may be made to the present disclosure, such as adding, changing, deleting, or supplementing components, without departing from the technical concept described in the claims. Such modifications or changes are also within the scope of the present disclosure.

What is claimed is:

1. An electrode for secondary batteries, the electrode comprising:
a current collector; and
an electrode mixture layer disposed on at least one surface of the current collector, wherein
the electrode mixture layer is divided into a first region extending a predetermined length from a winding start end in a winding direction and a second region extending from the first region to a winding termination end,
each of the first region and the second region comprises an active material, a conductive agent, and a binder,
the first region and the second region comprise binders with different contents, or the first region and the second region comprise different types of binders, and
the first region has higher ductility than the second region.

2. The electrode according to claim 1, wherein each of the first region and the second region comprises 93.5 to 97.5 wt % of the active material, 1 to 3 wt % of the conductive agent, and 0.5 to 3.5 wt % of the binder.

3. The electrode according to claim 2, wherein the content of the binder included in the second region is 2 wt % or less of a total weight of the electrode mixture layer in the second region.

4. The electrode according to claim 1, wherein the content of the binder in the first region is higher than the content of the binder in the second region.

5. The electrode according to claim 4, wherein the content of the binder included in the first region is 1.1 to 10 times the content of the binder included in the second region.

6. The electrode according to claim 1, wherein the binder in the first region has higher tensile elongation than the binder in the second region.

7. The electrode according to claim 6, wherein the tensile elongation of the binder included in the first region is 100% or more.

8. The electrode according to claim 1, wherein the first region is a region in which the electrode is wound 1 to 10 times from the winding start end in the winding direction.

9. The electrode according to claim 1, wherein the length of the first region is 80 to 400 mm.

10. The electrode according to claim 1, wherein the binder is at least one selected from a group consisting of polyvinylidene fluoride (PVDF), poly(vinylidene fluoride-co-hexafluoropropylene), polyacrylonitrile, polymethyl methacrylate, nitrile butadiene rubber (NBR), hydrogenated nitrile butadiene rubber (HNBR), polybutadiene rubber (BR), and styrene-butadiene rubber (SBR).

11. The electrode according to claim 1, wherein a thickness of the current collector is 20 μm or less.

12. The electrode according to claim 1, wherein the electrode is a positive electrode or a negative electrode.

13. The electrode according to claim 12, wherein
the electrode is a positive electrode and comprises a positive active material, and
an electrode density of the positive electrode active material is 3 g/cm³ or more.

14. An electrode assembly comprising:
a positive electrode;
a negative electrode; and
a separator located between the positive electrode and the negative electrode, wherein
the positive electrode is the electrode according to claim 1.

15. A battery cell comprising the electrode assembly according to claim 14.

16. A battery module comprising:
at least one battery cell, wherein
the battery cell is the battery cell according to claim 15.

17. A battery pack comprising:
at least one battery module, wherein
the battery module is the battery module according to claim 16.

18. An electrical device comprising:
at least one battery pack, wherein
the battery pack is the battery pack according to claim 17.
